(19) United States
(12) Patent Application Publication
(10) Pub. No.: US 2014/0013223 A1
(43) Pub. Date: Jan. 9, 2014

(54) SYSTEM AND METHOD FOR CONTEXTUAL VISUALIZATION OF CONTENT

(71) Applicants: Mohammad AAMIR, Richmond Hill (CA); Ming HAN, Brampton (CA); Mark D'CUNHA, Brampton (CA)

(72) Inventors: Mohammad AAMIR, Richmond Hill (CA); Ming HAN, Brampton (CA); Mark D'CUNHA, Brampton (CA)

(21) Appl. No.: 13/935,603

(22) Filed: Jul. 5, 2013

Related U.S. Application Data
(60) Provisional application No. 61/668,714, filed on Jul. 6, 2012.

(51) Int. Cl. G06F 17/21

(52) U.S. Cl. CPC G06F 17/212
USPC 715/273

(57) ABSTRACT

A system and method for contextual visualization of content. An exemplary system comprises a visualization module that can determine a sentiment and at least one other metric relating to the content. The metric could be any of recency, velocity and virality. The visualization module generates a plot for visualizing the sentiment and the at least one other metric.

### CROSS-REFERENCE

This application claims priority to U.S. Patent Application No. 61/668,714 filed Jul. 6, 2012, which is incorporated by reference herein.

### TECHNICAL FIELD

The following relates generally to contextual visualization of content.

### BACKGROUND

Massive amounts of information are available via the internet. With the growth of self-publishing tools, such as blogs, and social networking, individuals and businesses are increasingly able to publicize their views on certain topics while consumers and users actively seek out product and service information and share reviews and comments on their experiences. This creates vast amounts of user generated content such as conversations, statements and comments, whether critical, laudatory or neutral. However, given the amount of information on the internet, it is difficult for a business or brand to derive any meaningful context for the content, which correspondingly makes it difficult to leverage laudatory content or mitigate the fallout of critical content.

### SUMMARY

In one aspect, a system for contextual visualization of content is provided, the system comprising a visualization module operable to: (a) collect one or more content units from one or more content sources; (b) determine whether each content unit relates to a topic; (c) determine a polarity for each content unit and at least one other metric relating to the content unit; and (d) generate a plot comprising a plurality of data points for visualizing the polarity and the at least one other metric of the one or more respective content units.

In another aspect, a method for contextual visualization of content is provided, the method comprising: (a) collecting one or more content units from one or more content sources; (b) determining whether each content unit relates to a topic; (c) determining, by one or more processors, a polarity for each content unit and at least one other metric relating to the content unit; and (d) generating a plot comprising a plurality of data points for visualizing the polarity and the at least one other metric of the one or more respective content units.

### BRIEF DESCRIPTION OF THE DRAWINGS

Embodiments will now be described by way of example only with reference to the appended drawings wherein:

FIG. 1 is a system for contextual visualization of content;

FIG. 2 is an exemplary visualization;

FIG. 3 illustrates a method for generating a visualization; and

FIG. 4 illustrates a method of determining polarity.

### DETAILED DESCRIPTION OF THE DRAWINGS

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

A system and method for contextual visualization of content are provided. The content relates to a particular topic defined by the system or a user. Content available on a network, such as the internet, may be visualized based on one or more contexts. The contexts comprise the opinion for the content, recency, polarity, virality and velocity. The resulting visualization is particularly beneficial for enabling an interested party to determine whether its brand or messaging is being reacted to as desired. The visualization provides the party (e.g., a brand owner) with real-time or near real-time access to data reflecting the current public sentiment for the brand and can enable the party to take proactive, reactive or corrective measures to respond to the sentiment. The visualization presents a plurality of data points, each representing a content unit, and may enable the party to drill down in the visualization to determine particular content units from across the internet that are responsible for viral spreading of information or misinformation, that are swaying public opinion, that are beneficial or detrimental to the brand, etc. The party can access the originating content or representative content for each such content unit by selecting the respective data point in the visualization.

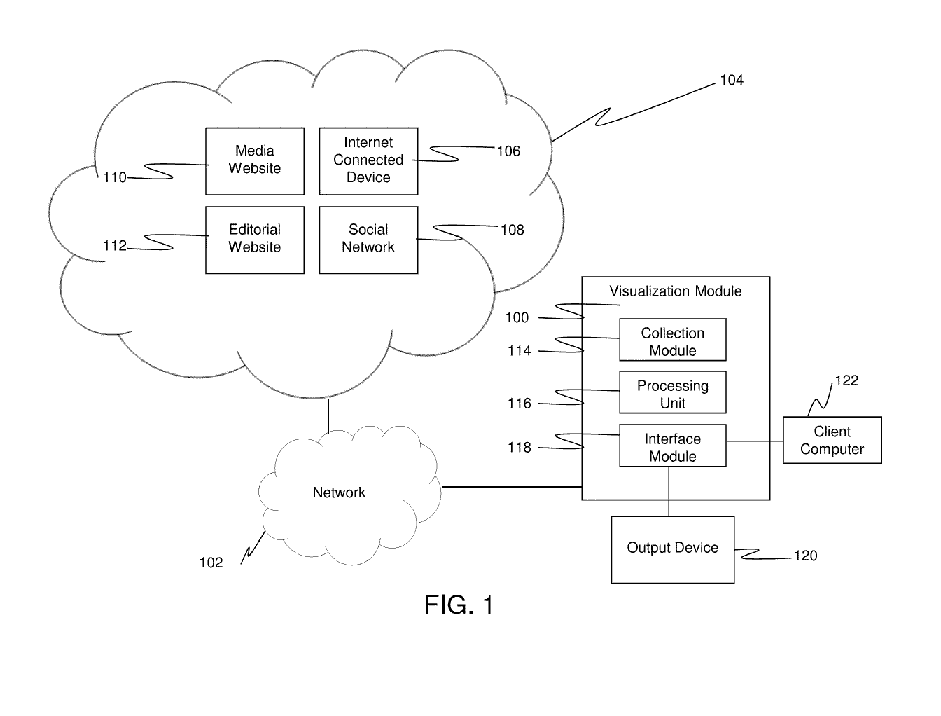

Referring to FIG. 1, a system comprising a visualization module 100 is provided. The visualization module 100 is linked via a network 102, such as the internet, to the cloud 104. The cloud 104 generally comprises a large amount of content (information), such as all or a majority of publicly available and/or private information on internet connected devices 106. The cloud may, for example, comprise a plurality of social networks 108, a plurality of media websites 110 and a plurality of editorial websites 112 (including, for example, news websites and blogs). Content available from these content sources comprises continuous feed and live streaming of transactional data, blog posts, reviews, web pages, web sites, articles, discussion forums including rich media, such as images, video, audio, social network status updates and posts, and social interactions including views, shares, comments, and likes. Content may be disseminated via proprietary applications and services. Each particular piece of content may be referred to as a content unit.

The visualization module 100 comprises a collection module 114, a processing unit 116 and an interface module 118. The collection module 114 is operable to obtain content from a plurality of content sources from the network 102. Optionally, the collection module 114 is operable to generate a similarity profile for a plurality of content units, such that it can determine whether two or more different content units are essentially similar and can be treated as the same if the similarity profile is above a particular threshold. In an example, a press release is often duplicated across the internet in news feeds, blogs with slight changes of title; or tweets and re-tweets and replies to tweets; each of which may be suitable for treating as the same.

The processing unit 116 filters the obtained content based on whether it relates to the topic and processes the obtained content to generate a visualization of the relevant content. The interface module 118 provides the visualization to a user using an output device 120, such as a computer monitor or tablet screen, for example.

The visualization is related to a topic. The topic may be provided by the user via a client computer 122 or could be a preconfigured topic, for example a static topic associated with a user account. The visualization enables the user to visualize the context corresponding to content that is relevant to the topic. The user can navigate the visualization to develop a meaningful understanding of the context to further develop an understanding of public opinion, such as sentiment, emotion, mood, attitude or intent toward the topic.

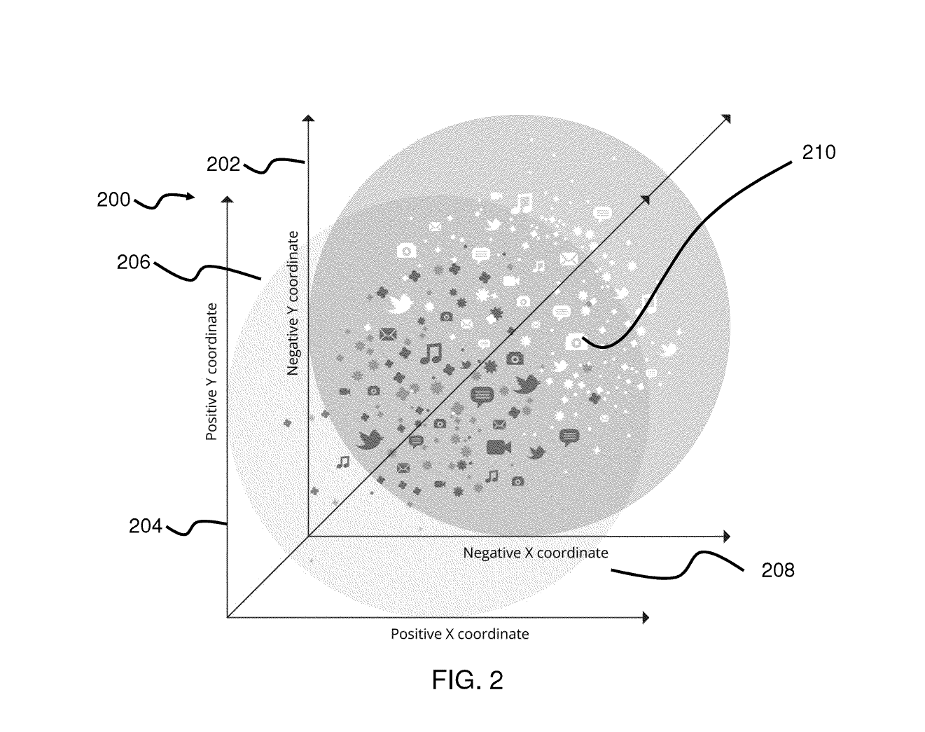

Referring now to FIG. 2, an example visualization 200 is shown as two partially overlapping plots 202, 204 each comprising a plurality of data points, which are also referred to herein as particles. The plots may be n-dimensional, although four dimensional plots are shown. Each four dimensional plot may represent four dimensions by plotting data points along its X and Y axes (two dimensions), varying the size of each data point (a third dimension), and varying the appearance of the data point (a fourth dimension), such as by varying an icon representing the data point.

The two plots may be separated by a configurable distance 206, 208 in both the X and Y axes, such that portions of the plots may overlap or may be sufficiently separated. The overlap of the plot axes may be determined by optimizing the overlap of particles displayed in each plot, as will be described. It will be appreciated that while two plots are shown in FIG. 2, any number of one or more such plots may be provided.

The two plots shown in the example of FIG. 2 represent a polarity point such as the positive sentiment plot and the opposite polarity point such as the negative sentiment plot. The origin of the negative sentiment plot 202 is shown to the left and below the origin of the positive sentiment plot 204, though the relative placement of the plots may be configured differently. One example wherein more than two plots may be used includes four plots representing a point scale, such as highly positive, somewhat positive, highly negative and somewhat negative.

On each plot, each data point 210 may represent a content unit relating to the predefined topic. The data point may further comprise a pointer, or link, to the content unit. Optionally, for aesthetic purposes (e.g., to reduce crowding), data points may comprise a plurality of such units of content and additional methods, described herein, could be used to differentiate between such content should it be desired by the user. These methods could include, for example, zooming, selected refinement (e.g., showing the units of content upon clicking the data point), selectively hiding data points of particular content types, or some other differentiation method.

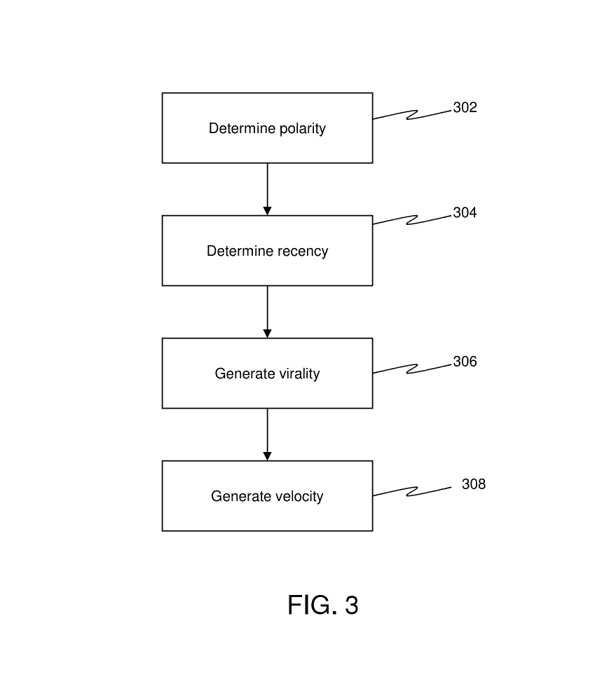

As show in FIG. 3, the visualization module generates the visualization by determining the polarity of content 302 relating to the topic, determining whether the content is of sufficient recency 304, and generating a virality 306 and a velocity 308 for the content.

The processing unit is operable to generate a polarity metric for each such content unit and determine whether such content is of a sufficient recency. The processing unit generates a polarity metric for each content unit to represent the opinion associated with the content, whether it is a more positive or more negative sentiment or mood. The polarity metric may be assigned a value along a scale (e.g., 0 to 10), a relative scale point (e.g., negative or positive; or negative, neutral, positive), or any combination thereof. Other analogous sentiments could also be assigned, including, for example, bearish and bullish of the market, buy and sell of stock ticker or industry, support and reject of a politician, to uncover trends that are forming, affective states of public, or sentiment toward that time classifications. These polarities may further be segmented and grouped by a plurality of classes, for example weak, neutral and strong.

The processing unit may determine whether particular content comprises structured content, unstructured content or rich content. Structured content is content that is quantifiable or may be universally interpreted consistently or parsed without loss of context. For example, numeric and discrete content are typically structured content. Examples include stock quotes, buy/sell transactions, polls and votes. The processing unit applies a quantitative analysis to determine the polarity metric for structured content. For example, if a stock price has increased more than a particular threshold (which may be 0), the polarity metric may generally be positive.

Unstructured content is content that may require additional interpretation prior to understanding the meaning of such content; for example, it may comprise natural language. Examples of unstructured content are social media updates, news articles and blog entries. Rich content is content that is not entirely textual, including: image, video and audio.

The processing unit determines whether the content relates to the topic and determines the polarity of unstructured and rich content by using natural language processing and machine learning. The polarity is determined with respect to a given topic, which could be a brand, product, service, corporate image, interest, item, etc.

Machine learning based natural language processing comprises training a classifier and applying the classifier to content. One example of a classifier is a Naïve Bayes classifier.

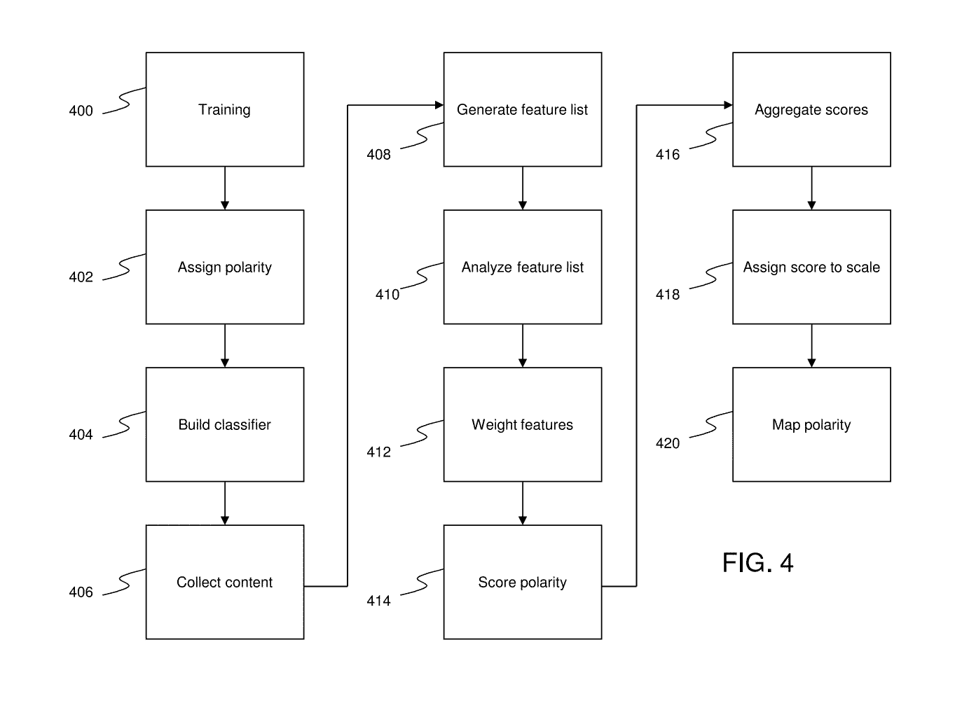

FIG. 4 illustrates one example of determining polarity of the content. In block 400, a natural language processing unit which applies machine learning is trained with a training set which comprises a plurality of content messages representing the corpus, where each content message has been rated with a polarity. In block 402, the polarity can be assigned to a scale, such as “negative” vs “somewhat negative”, with corresponding probability to appear in a particular corpus, such as tweets vs facebook post. In block 404, the Naive Bayes classifier is built based on the training set to determine the polarity of any input textual content.

The processing unit may also train classifiers to analyze images and video frames to determine their features such as containing a facial expression (e.g. a smiling expression is generally positive), or flora arrangement (e.g. a blooming flower is generally positive), or colours (e.g. a bright background is generally positive).

The training set may further comprise content to enable the training of classifiers for complex textual input, such as hashtags, URLs, handles, emoticons and acronyms and colloquialisms, for example. In the case of hashtags, for example, they may be processed as phrases using n-gram words. In the case of emoticons, for example, the emoticon commonly represented by :) may be associated with “positive” while the emoticon commonly represented by :( may be associated with “negative”. Acronyms and colloquialisms, for example, include terms such as LOL (laugh out loud) and SNH (sarcasm noted here).

In block 406, the collection module collects content from the cloud and communicates the content to the processing unit. In block 408, the processing unit applies feature extraction to the collected content to generate a feature list and, in block 410, the classifiers analyze the feature list for the collected content. For content spanning multiple sentences, depending on the content source (channel), either the first sentence or last sentence could be considered the most important and influential for the sentiment.

In block 412, the presence of features in the content, such as having a particular structure, is weighted with a probability rating to determine the scale of the polarity in sentiment.

In block 414, the probability of each feature is scored for its polarity and, in block 416, the scores for all features are aggregated to assign a weighting for the content. In block 418, the weighting may be assigned within a scale, for example from 0 to 10. In block 420, the weighting is mapped to the selected polarity metric if the metric is not on the same scale (e.g., if the metric is negative, neutral, positive), e.g. where 0-4 is negative, 4-6 is neutral and 6-10 is positive.

The processing unit also determines recency of the content unit. Recency is a function of time and may vary depending on the type of content the data point represents. Certain content on the network may be understood to have a particular threshold amount of relevance for only a short time while other content may be understood to have a particular threshold amount of relevant for a longer time. For example, a social media update typically has a short lifetime relevance while a news article typically has a longer lifetime relevance.

Recency is determined based on the amount of time content has existed on the network and the type of content. Content may be considered either of a sufficient recency to be relevant or insufficient recency, in which case it is irrelevant. Content of sufficient recency is more recent than a particular threshold. Such a recency may be referred to as falling within a “recency unit” for that type of content. In one example, any social media update is considered of sufficient recency if it was disseminated within one hour and, in this example, the recency unit is one hour.

The processing unit determines a content population for each content unit within its recency unit. The content population is determined by first generating a publishing frequency and interval for the content unit within the recency unit. The frequency and interval is determined based on the standard deviation of publishing the content unit. The standard deviation provides a variance of the content publishing frequency and interval. Based on the variance, an average publishing interval in the recency unit. For each content type this computation is repeated to determine its respective recency unit.

Content units may be determined to be relatively similar if they meet or exceed a particular similarity threshold. The content may be identified and parsed for its uniqueness through a similarity profile which may be supplemented with Statistically Improbable Phrases (SIP). The collection module is operable to generate a similarity profile for a plurality of content units, such that it can determine whether two or more different content units are essentially similar and can be treated as the same if the similarity profile is above a particular threshold. In an example, a press release is often duplicated across the internet in news feeds, blogs with slight changes of title; or tweets and re-tweets and replies to tweets; each of which may be suitable for treating as the same. This is to ensure the messages that are the same but syndicated across different channels are identified and the message content is assigned with a unique id but referenced across these channels.

Similarity may be based on a plurality of conditions. A first condition is message title, which may be considered similar if it is an exact match for all or portion of the title, if the title of one is a subset of the title of the other. A probably score may be generated based on the amount of similarity and length of the title.

A second condition is message body, which may be considered similar if it is an exact match for the whole content, of if the message body of one is a subset of the message body of the other. A match score may be generated based on the position that matched content starts or ends.

A third condition is message author, which may be considered similar if the name or handle matches.

A fourth condition is excluding words. If certain words and phrases are present in the content, then the content is not considered the same (e.g., in Twitter, the presence of “RT” or “RE” along with a content match less than 80% indicates the content is not a duplicate). The match probability and percentage match is determined to identify if the original content is duplicated, and if the duplication has been enriched further. If the enrichment is significant, such as reaching 30% of the content for example, then it may be considered a new piece of content with a reference to an existing content. Enriched content may be used to either validate or detract the original user's point of view, or express emotion and opinion to that original content.

A fifth condition is SIP, which may be applied to ensure the match of these words. Bi-gram, tri-gram and n-gram words can increase the accuracy of a match for articles and blogs. Bi-grams, tri-grams and n-grams may provide increased accuracy for brief content, such as social media posts. The bi-grams, tri-grams and n-grams may be particularly helpful for social media posts (short messages) since users often try to “squeeze” as much content as possible into a small space, which can lead to creating phrases (e.g., of length two or three, i.e., bi-grams and tri-grams) that are then widely used. It is this process that often leads to commonly used internet abbreviations.

A sixth condition determines the matching of the inclusion of referenced objects, such as the same URLs, hashtag, and user handles with the same adjacent words, and co-occurrence of certain words, phrases and referenced objects. Named entity recognition can also be used to identify names and locations to increase the accuracy of the duplicate content and thus increase the detection of unique content.

The processing unit further determines virality for each content unit. A viral count comprises the sum of all social media comments, likes, shares, views, etc. for the content unit within its respective recency unit.

A velocity is then generated. Velocity indicates the speed at which a particle reaches its virality. The faster of velocity, the higher its Y coordinate. Since velocity can be represented as velocity =virality/recency, the Y coordinate can be same as the velocity or adjusted with scaling factor.

The interface module obtains from the processing unit a pointer to each content unit along with the corresponding polarity, recency, virality and velocity. The interface module may group content among a plurality of polarity groups by applying thresholds to the polarity. For example, all content having a negative polarity may be assigned to a first group while all content having a positive polarity may be assigned to a second group.

The plurality of groups are output to a plurality of plots, respectively. In other words, a first plot plots the first group while a second plot plots the second group. The output utility may enable a user to configure an offset for the plurality of plots it wishes to have displayed, or could allow them all to overlap. The offset may be defined in X and Y coordinates.

Each content unit is assigned a particle which is a point on the visualization. The shape of the particle may be assigned based on the content type, for example by allocating a particular icon to each type of content.

The size of the particle may be assigned based on virality. The size may also be required to be between a particular minimum and maximum. An exemplary size may be determined by the formula size=x+virality rate=x+(y-x)*viral count/maximum viral count, where x is minimal size allocated to the particle icon, y is the maximum size allocated to the particle icon, the viral count is the virality for that particle, such as number of likes at that time point, and maximum viral count is the maximum of the viral counts for that particular type of particle in one recency unit.

The particles above a particular threshold polarity may be plotted on a first plot, and below the particular polarity on a second plot. The population of particles is determined to ensure that there is enough space (e.g., monitor space) to discern the particles once plotted. If not, the plot may be zoomed, particular content types may be not plotted, or the polarity threshold may be modified.

The X axis of each plot may represent recency of the particle.

The Y axis of each plot may represent velocity of the particle.

Optionally, the plot, or any particular type of particle, may be time-expanded. For example, a user may configure the plot to display an integer or real multiple of the recency unit.

The processing unit provides the plots to the interface unit for displaying to a user using a display.

Although the above has been described with reference to certain specific example embodiments, various modifications thereof will be apparent to those skilled in the art without departing from the scope of the claims appended hereto.

We claim:

1. A system for contextual visualization of content comprising a visualization module operable to:
(a) collect one or more content units from one or more content sources;
(b) determine whether each content unit relates to a topic;
(c) determine a polarity for each content unit and at least one other metric relating to the content unit; and
(d) generate a plot comprising a plurality of data points for visualizing the polarity and the at least one other metric of the one or more respective content units.

2. The system of claim 1, wherein the polarity represents one or more of sentiment, emotion, mood, attitude or intent toward the topic.

3. The system of claim 1, wherein the each content unit is assigned a polarity along a numeric scale, a relative scale, or a combination thereof.

4. The system of claim 3, wherein the polarity of each content unit comprising unstructured content is determined by applying a natural language classifier trained by a natural language processing machine.

5. The system of claim 3, wherein the polarity of each content unit comprising rich content is determined by applying a feature classifier trained by machine learning.

6. The system of claim 1, wherein the at least one other metric is one or more of recency, virality and velocity.

7. The system of claim 6, wherein each content unit is assigned a recency that is a function of time and the visualization module determines whether the assigned recency is within the recency unit for the respective content type.

8. The system of claim 6, wherein the virality is determined by generating a similarity profile for each unit of content available within a recency unit.

9. The system of claim 8, wherein the similarity profile is generated based on a plurality of conditions selected from message title, message body, message author, excluding words, Statistically Improbable Phrases, inclusion of referenced objects, and any combination thereof.

10. The system of claim 6, wherein the virality is determined based on the sum of all social media activity for the content unit within the its respective recency unit.

11. A method for contextual visualization of content comprising:
(a) collecting one or more content units from one or more content sources;
(b) determining whether each content unit relates to a topic;
(c) determining, by one or more processors, a polarity for each content unit and at least one other metric relating to the content unit; and
(d) generating a plot comprising a plurality of data points for visualizing the polarity and the at least one other metric of the one or more respective content units.

12. The method of claim 11, wherein the polarity represents one or more of sentiment, emotion, mood, attitude or intent toward the topic.

13. The method of claim 11, wherein the each content unit is assigned a polarity along a numeric scale, a relative scale, or a combination thereof.

14. The method of claim 13, wherein the polarity of each content unit comprising unstructured content is determined by applying a natural language classifier trained by a natural language processing machine.

15. The method of claim 13, wherein the polarity of each content unit comprising rich content is determined by applying a feature classifier trained by machine learning.

16. The method of claim 11, wherein the at least one other metric is one or more of recency, virality and velocity.

17. The method of claim 16, wherein each content unit is assigned a recency that is a function of time and the visualization module determines whether the assigned recency is within the recency unit for the respective content type.

18. The method of claim 16, wherein the virality is determined by generating a similarity profile for each unit of content available within a recency unit.

19. The method of claim 18, wherein the similarity profile is generated based on a plurality of conditions selected from message title, message body, message author, excluding words, Statistically Improbable Phrases, inclusion of referenced objects, and any combination thereof.

20. The method of claim 16, wherein the virality is determined based on the sum of all social media activity for the content unit within the its respective recency unit.
